(19) United States
(12) Patent Application Publication
(10) Pub. No.: US 2024/0154903 A1
(43) Pub. Date: May 9, 2024

(54) CYCLIC DRAGONFLY AND MEGAFLY

(71) Applicant: CORNELIS NETWORKS, INC., WAYNE, PA (US)

(72) Inventors: GARY MUNTZ, LEXINGTON, MA (US); ARUNA RAMANAN, EASTON, PA (US)

(73) Assignee: CORNELIS NETWORKS, INC., WAYNE, PA (US)

(21) Appl. No.: 18/194,168

(22) Filed: Mar. 31, 2023

Related U.S. Application Data
(60) Provisional application No. 63/382,800, filed on Nov. 8, 2022.

(51) Int. Cl. H04L 45/586; H04L 45/12; H04L 45/121

(52) U.S. Cl. CPC H04L 45/586; H04L 45/121; H04L 45/123

(57) ABSTRACT

Routing in a multi-computer network comprising a plurality of multi-switch virtual router groups (‘VRGs’) interconnected by only cyclic connections among the VRGs is provided. A cyclic connection is formed by connecting one switch from each VRG in a cyclic set of VRGs to the same switch in every other VRG in the cyclic set and each switch in the cyclic set is connected in an all-to-all configuration. Every VRG in the network has at least one cyclic connection with every other VRG in the network. Embodiments include selecting a non-minimal path between a source VRG and a destination VRG in a cyclic set that passes through only one switch in a pass-through VRG in the cyclic set; and sending packets from the source VRG in the cyclic set to the destination VRG through the one switch in the pass-through VRG.

This application claims the benefit of U.S. Provisional Application No. 63/382,800 filed Nov. 11, 2022, all of which is incorporated herein by reference in its entirety.

### BACKGROUND

High-Performance Computing (‘HPC’) refers to the practice of aggregating computing in a way that delivers much higher computing power than traditional computers and servers. HPC, sometimes called supercomputing, is a way of processing huge volumes of data at very high speeds using multiple computers and storage devices linked by a cohesive fabric. HPC makes it possible to explore and find answers to some of the world's biggest problems in science, engineering, business, and others.

Various high-performance computing systems support topologies with interconnects that can support both deterministic routing and adaptive routing. In deterministic routing, the path is typically determined by the source and destination nodes. Adaptive routing is a mechanism to avoid delay due to contention in a fabric by selecting possible alternate, less-congested links and switches. Both deterministic and adaptive routing may transmit packets along a shortest or minimal path or along a longer non-minimal path between a source and a destination. Conventional connectivity patterns for global links in topologies useful in HPC have drawbacks. While such conventional methods may accommodate scale more easily than cyclic solutions, these conventional connectivity patterns do not enable efficient multi-hop telemetry. It would be advantageous to have an efficient and effective mechanism to provide routing with efficient non-minimal routing.

### BRIEF DESCRIPTION OF THE DRAWINGS

Many aspects of the present disclosure can be better understood with reference to the following drawings. The components in the drawings are not necessarily to scale, with emphasis instead being placed upon illustrating the principles of the disclosure. Moreover, in the drawings, like reference numerals designate corresponding parts throughout the several views.

FIG. 1 sets forth a system diagram of an example high-performance computing environment useful in routing in a multi-computer network according to some embodiments of the present invention.

FIG. 2 sets forth a line drawing of a Dragonfly topology useful according to embodiments of the present invention.

FIG. 3 sets forth a line drawing of a partial Dragonfly topology that demonstrates a cyclic configuration from one VRG's perspective according to example embodiments of the present invention.

FIG. 4 sets forth a line drawing of an example of a complete cyclic Dragonfly topology.

FIG. 5 sets forth a block diagram of an example system for routing in a multi-computer network according to example embodiments of the present invention.

FIG. 6 sets forth a line drawing illustrating example telemetry advantages of a cyclic topology.

FIG. 7 sets forth a topology useful with and benefitting routing in a multi-computer network according to embodiments of the present invention.

FIG. 8 sets forth another topology both useful with and benefitting from routing in a multi-computer network according to embodiments of the present invention.

FIG. 9 sets forth a block diagram of a compute node useful in routing in a multi-computer network according to embodiments of the present invention.

FIG. 10 sets forth a block diagram of an example switch.

FIG. 11 sets forth a flowchart illustrating a method of routing in a multi-computer network.

FIG. 12 sets forth a flowchart illustrating an example method of creating a high-performance computing environment.

FIGS. 13a and 13b, FIGS. 14a and 14b, and 15a and 15b set forth matrices that illustrate the permutation properties of an example set of matrices that implement the configuration of a cyclic topology according to embodiments of the present invention.

### DETAILED DESCRIPTION

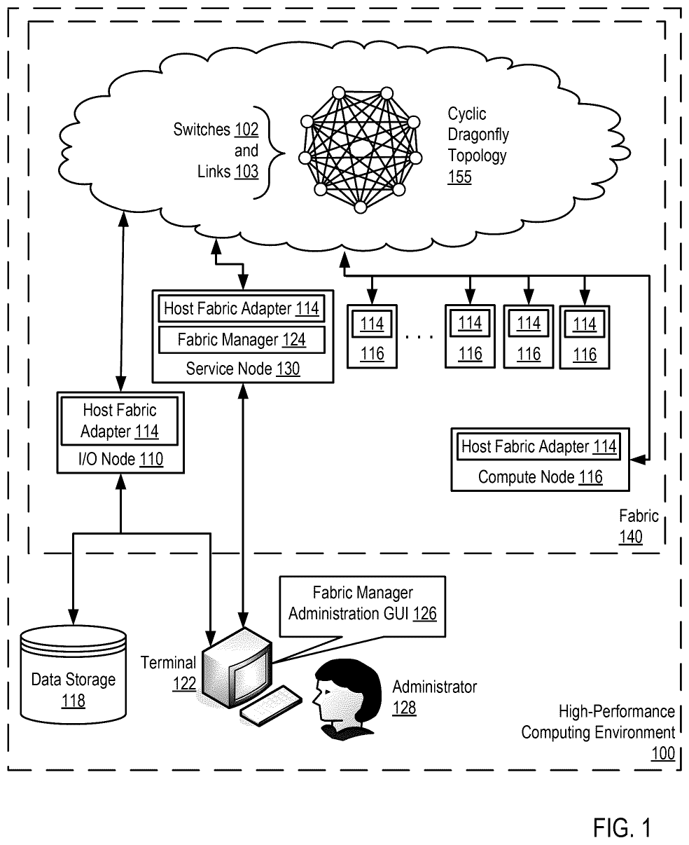

Methods, systems, devices, and products for routing in a multi-computer high-performance computing (‘HPC’) network are described with reference to the attached drawings beginning with FIG. 1. Routing in a multi-computer cyclic topology according to embodiments of the present invention is amenable to both adaptive and deterministic routing. FIG. 1 sets forth a system diagram of an example high-performance computing environment (100) useful in routing in a cyclic computer topology according to some embodiments of the present invention. One example topology useful in embodiments of the present invention is a cyclic Dragonfly. A Dragonfly topology is computing topology in which a collection of switches belonging to the virtual router group (‘VRG’) are connected with intra-group connections called local links and those VRGs are connected all-to-all with other VRGs with inter-group connections called global links. As discussed in more detail below, example Dragonfly topologies of the present invention are cyclic to include wiring patterns using ‘cycles’ of global links that avoid the use of local links in pass-through virtual router groups.

Topologies according to embodiments of the present invention are most commonly discussed with reference to a cyclic Dragonfly. As will occur to those of skill in the art, a Megafly, also known as Dragonfly+, is a special type of Dragonfly in which the VRGs are configured as a two-tiered fat tree. The VRGs of a Megafly are connected to one another in the same way as the VRGs in a Dragonfly. Therefore, inventive cyclic topologies primarily discussed with reference to Dragonflies are equally applicable to Megaflies. That said, Dragonflies and Megaflies are not the only topologies that can be created using cyclic connections and as such routing according to embodiments of the present invention are not limited to only Dragonflies and Megaflies.

The example high-performance computing environment of FIG. 1 includes a fabric (140) which includes an aggregation of a service node (130), an Input/Output (“I/O”) node (110), a plurality of compute nodes (116) each including a host fabric adapter (‘HFA’) (114), and a topology (155) of switches (102) and links (103). The service node (130) of FIG. 1 provides services common to a plurality of compute nodes, loading programs into the compute nodes, starting program execution on the compute nodes, retrieving results of program operations on the compute nodes, and so on. The service node of FIG. 1 runs a service application and communicates with administrators (128) through a service application interface that runs on computer terminal (122). Administrators typically use the fabric manager to configure the fabric, and the nodes themselves, as required. Users (not depicted) often interact with one or more applications but not the fabric manager. As such, the fabric manager is used only by privileged administrators, running on specific nodes, because of the security implications of configuring the fabric.

The fabric (140) according to the example of FIG. 1 is a unified computing system that includes nodes interconnected by links in a manner that often looks like a weave or a fabric when seen collectively. In the example of FIG. 1, the fabric (140) includes compute nodes (116), host fabric interfaces (114) and switches (102). The switches (102) of FIG. 1 are coupled for data communications to one another with links to form one or more topologies (155). The example of FIG. 1 illustrates an abstraction of a cyclic topology (155) adapted for routing according to embodiments of the present invention and discussed in more detail below.

The compute nodes (116) of FIG. 1 operate as individual computers including at least one central processing unit (‘CPU’), volatile working memory and non-volatile storage. The compute nodes of FIG. 1 are connected to the switches (102) and links (103) through a host interface adapter (114). The hardware architectures and specifications for the various compute nodes vary and all such architectures and specifications are well within the scope of the present invention as will occur to those of skill in the art. Such non-volatile storage may store one or more applications or programs for the compute node to execute. Such non-volatile storage may be implemented with flash memory, rotating disk, hard drive or in other ways of implementing non-volatile storage as will occur to those of skill in the art.

As mentioned above, each compute node (116) in the example of FIG. 1 has installed upon it or is connected for data communications with a host fabric adapter (114) (‘HFA’). Host fabric adapters according to example embodiments of the present invention deliver high bandwidth and increase cluster scalability and message rate while reducing latency. The example HFA (114) of FIG. 1 connects a host such as a compute node (116) to the fabric (140) of switches (102) and links (103). The HFA adapts packets from the host for transmission through the fabric. The example HFA of FIG. 1 provides matching between the requirements of applications and fabric, maximizing scalability and performance. The HFA of FIG. 1 provides increased application performance including dispersive routing and congestion control.

The service node (130) of FIG. 1 has installed upon it a fabric manager (124). The fabric manager (124) of FIG. 1 is a module of automated computing machinery for configuring, monitoring, managing, maintaining, troubleshooting, and otherwise administering elements of the fabric (140). The example fabric manager (124) is coupled for data communications with a fabric manager administration module with a graphical user interface (‘GUI’) (126) allowing administrators (128) to configure and administer the fabric manager (124) through a terminal (122) and in so doing configure and administer the fabric (140). In some embodiments of the present invention, routing algorithms are controlled by the fabric manager (124) which in some cases configures routes from endpoint to endpoint.

The example of FIG. 1 includes an I/O node (110) responsible for input and output to and from the high-performance computing environment. The I/O node (110) of FIG. 1 is coupled for data communications to data storage (118) and a terminal (122) providing information, resources, GUI interaction and so on to an administrator (128).

The switches (102) of FIG. 1 are multiport modules of automated computing machinery, hardware and firmware, which receive and transmit packets. Typical switches (102) receive packets, inspect packet header information, and transmit the packets according to routing tables configured in the switch. Often switches are implemented as or with one or more application specific integrated circuits (‘ASICs’). In many cases, the hardware of the switch implements packet routing and firmware of the switch configures routing tables, performs management functions, fault recovery, and other complex control tasks as will occur to those of skill in the art. Switches according to embodiments of the present invention may include a circuit module adapted for receiving and transmitting telemetry data. Such telemetry for feedback and congestion control provides fine-grained network load information including for example, queue length, transmitted bytes, timestamp, link capacity and other information. Telemetry for adaptive routing is discussed in U.S. patent application Ser. Nos. 17/359,367; 17/359,358; and 17,359,371, all of which are incorporated by reference herein in their entirety.

The switches (102) of the fabric (140) of FIG. 1 are connected to other switches with links (103) to form one or more topologies. Links (103) may be implemented as copper cables, fiber optic cables, and others as will occur to those of skill in the art.

A topology is the wiring pattern and a matching routing algorithm. Compute nodes, HFAs, switches and other devices, and switches may be connected in many ways to form and many topologies, each designed to perform in ways optimized for their purposes. In the example of FIG. 1, the switches (102) and links (103) are connected in a cyclic Dragonfly (155) topology according to embodiments of the present invention and discussed in more detail below.

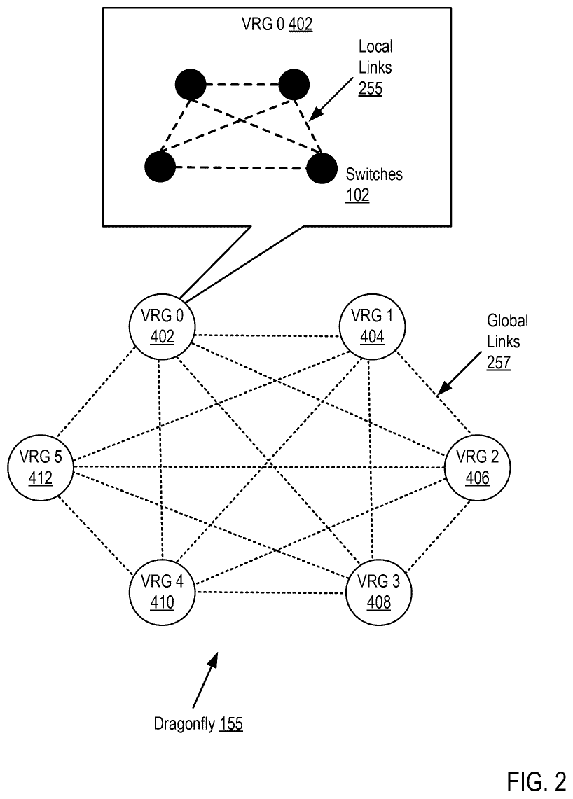

Example cyclic topologies useful according to embodiments of the present invention are described primarily herein as inventive cyclic Dragonflies and Megaflies. For further explanation, FIG. 2 sets forth a line drawing of a Dragonfly topology useful according to embodiments of the present invention. The Dragonfly topology (155) includes a plurality of virtual router groups, VRG 0-VRG 5 (402-412). Each VRG (402-412) is a collection of switches (102) connected by local links (255) as illustrated in the call out of VRG 0 (402). Typically, a given VRG is packaged within a rack with all connections provided in copper. The intra-switch links within a VRG are termed “local links” (255).

In the example Dragonfly of FIG. 2, at least one switch in each VRG is connected to at least one switch in every other VRG. Multiple VRGs, often in different racks, are typically connected using inter-switch “global links” (257) that often utilize longer, expensive optical cables.

The example topology (155) of FIG. 2 is a hierarchical, multi-hop network that can utilize forward congestion information, such as telemetry data, to steer a packet along a less congested non-minimal path. In the example of FIG. 2, a non-minimal path between a source VRG to a destination VRG will traverse a pass-through VRG. A pass-through VRG is as it sounds—a VRG that has a switch along a non-minimal path for packets to pass-through between a source VRG and a destination VRG. As discussed in more detail below, the Dragonfly topology of the present invention is cyclic and provides an efficient non-minimal path with two consecutive global hops via a pass-through VRG to any other VRG.

Also discussed in more detail below, this inventive wiring pattern among the VRGs provides a non-minimal path that does not employ any local links within a pass-through VRG. Eliminating the use of local links in a pass-through VRG is both efficient in transmission of packets but also efficient in selecting a non-minimal path because only two hops of telemetry data is required to traverse from a source VRG to a destination VRG through a single switch in the pass-through VRG. Those of skill in the art will recognize that in traditional topologies telemetry data with more than a two-hop look ahead is required to track congestion in the last global link of the path because local links are employed in pass-through VRGs. Furthermore, the global link telemetry is the most important for tracking because global links have the highest potential for congestion. Two hops of telemetry provide complete visibility of all global links in a non-minimal path of cyclic topologies of the present invention—and this is not true with non-cyclic wiring patterns.

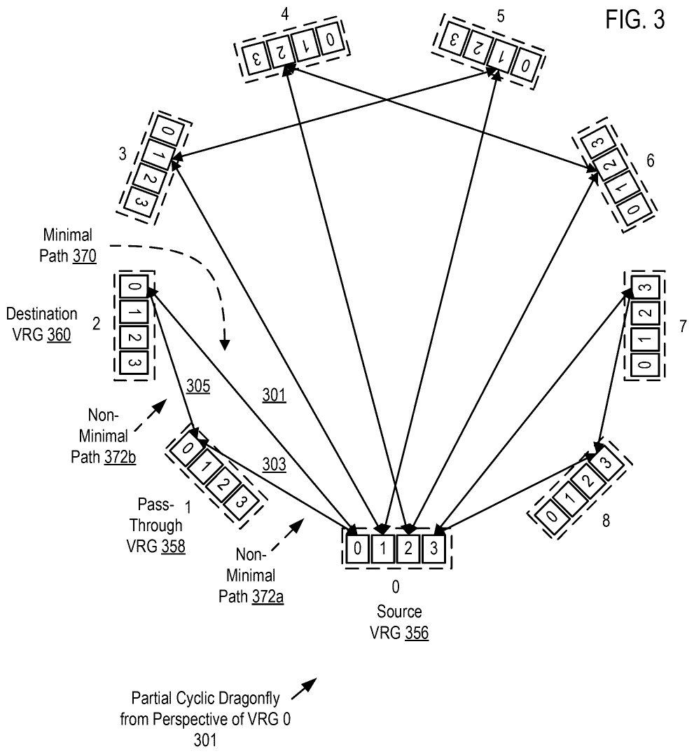

As mentioned above, the inventive topologies of the present invention employ a wiring pattern called “cycles” or “cyclic connections.” In this disclosure, the terms cycles and cyclic connections are often used interchangeably. For further explanation, FIG. 3 sets forth a line drawing of a partial Dragonfly topology that demonstrates a cyclic configuration from the perspective of one VRG according to example embodiments of the present invention. That is, the example of FIG. 3 illustrates the connectivity pattern of 4 cycles from the perspective of only one of the VRGs. This partial depiction of a Dragonfly uses switches of radix 8, providing 2 global ports each. Only the global links are shown in this figure.

FIG. 3 illustrates this partial Dragonfly topology with nine VRGs (VRG 0-VRG 8). Each VRG has four switches, switch 0, switch 1, switch 2, and switch 3. In the example of FIG. 3, VRG 0 is connected with a global link to every other VRG in the topology. In a complete Dragonfly, each switch within each VRG is also connected to every other switch in the VRG with local links.

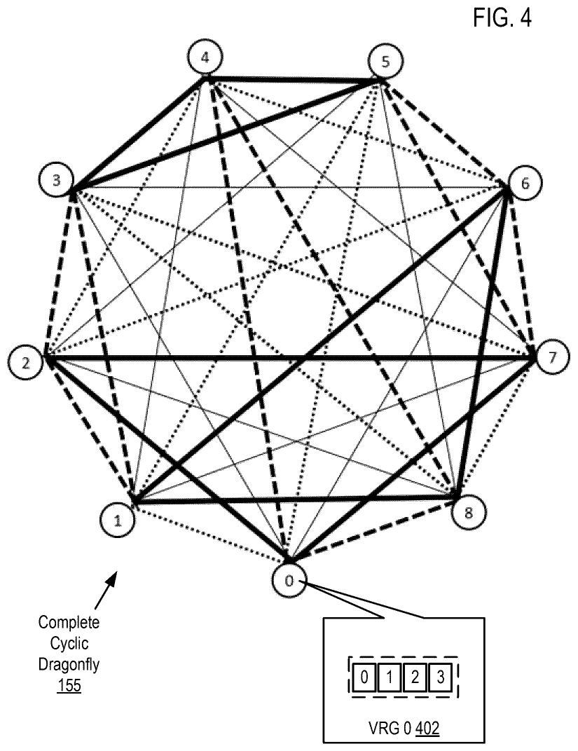

For ease of explanation, the cyclic connections of the Dragonfly topology of FIG. 3 are only depicted from the perspective of VRG 0 (356), which is also used as the source VRG (356) in this example. A complete cyclic Dragonfly of the same VRG arrangement has each VRG connected with a global link to every other VRG in the topology as depicted in FIG. 4. In the example of FIG. 3, each VRG will use both global link ports of each of its switches and every global link is part of a triangle of three links, as shown in FIG. 3. More particularly, links 301, 303 and 305 are global links connecting switch 0 in VRG 0 (356), switch 0 in VRG 1 (358), and switch 0 in VRG 2 (360). These three global links (301, 303, and 305) form a triangle and those of skill in the art will recognize that a non-minimal path exists among the switches of the cycle that requires no local traffic or hops that are not in the cycle.

These triangles are cyclic connections according to embodiments of the present invention. A cyclic connection in the example of FIG. 3 is formed by connecting one switch from each VRG in a cyclic set of VRGs to the same switch in every other VRG in the cyclic set. In the example of FIG. 3, VRG 0 (356) has four switches switch 0, switch 1, switch 2, and switch 3. One example cyclic connection is formed among VRG 0 and VRG 1 (358) and VRG 2 (360) with three global links (301, 303, and 305). In this example, the cyclic set of VRGs includes VRG 0 (356) and VRG 1 (358) and VRG 2 (360).

Each VRG in the cyclic set has a switch with a global link with the same switch as the other two VRGs in the cycle. In the example of FIG. 3, switch 0 in VRG 0 has a global link to switch 0 in VRG1 and switch 0 in VRG 2 has a global link to the same switch, switch 0, in VRG 1. Similarly, switch 0 in VRG 1 has a global link to switch 0 in VRG 0 and switch 0 in VRG 2 has a global link to the same switch, switch 0, in VRG 0. Switch 0 in VRG 2 has a global link to switch 0 in VRG 0 and switch 0 in VRG 1 has a global link to the same switch, switch 0, in VRG 0. Each switch in the cyclic set is connected in an all-to-all configuration. As such, each VRG in the cyclic set (VRG 0, VRG, 1, VRG 2) is connected all-to-all through the same switches in each VRG.

The example of FIG. 3 illustrates a cyclic connection with links (301, 303, and 305) each connected to a switch designated as switch 0 in the respective VRGs in the cyclic set. This is for ease of explanation and not for limitation. There is no requirement that the switches connecting the links of the cycle be designated with the same switch ID. Regardless of ID give, a single physical switch connects two links of the cyclic set to the other VRGs in the cyclic set such that pass-through traffic occurs through that single physical switch (and therefore the pass-through VRG itself) eliminating the need for any local hops within the pass-through VRG.

Each VRG has a direct global link to a switch in every other VRG in the cycle thereby creating a minimal path (370) from a source VRG (356) to a destination VRG (360) and a non-minimal path (372a and 372b) from the source VRG to a destination VRG. Switch 0 in source VRG (356) has a direct global link (301) to switch 0 in the destination VRG (360) creating a minimal path (370) along the global link (301) between source VRG (356) and destination VRG (360). Switch 0 in source VRG (356) also has a global link (303) to switch 0 in a pass-through VRG (358) which in turn itself has a global link (305) to switch 0 in the destination VRG (360) creating a non-minimal path (372a and 372b) between the source VRG (356) and the destination VRG (360) through the pass-through VRG (358). The minimal path (370) from the source VRG (356) and the destination VRG (360) and the two-hop non-minimal path (372a and 372b) through the pass-through VRG (358) creates a cycle according to embodiments of the present invention and as that term is used in the present disclosure. The non-minimal paths of the cyclic connections of the present invention eliminate any local traffic in a pass-through VRG.

The benefits of this cyclic connection are myriad and will be apparent to those of skill in the art. For example, the wiring configuration of the example of FIG. 3 provides that when congestion along a minimal path (370) is inefficient, an efficient non-minimal path (372a and 372b) exists using only global links (303 and 305) and using no local links within the pass-through VRG (358). As such, the example of FIG. 3 provides an efficient use of non-minimal routing according to example embodiments of the present invention. The availability of two-hop non-minimal routing requires less telemetry data and computational overhead to determine whether to use a minimal or non-minimal route, compared with a traditional Dragonfly. The telemetry also has lower latency because it also avoids a local hop. The non-minimal route also provides job isolation in that traffic through the pass-through VRG does not interfere with local traffic within the VRG. Local traffic is also not competing with pass-through traffic aiding efficiency within the VRG. Pass-through traffic on one switch does not interfere with pass-through traffic on another switch in the same VRG.

As mentioned above, the example of FIG. 3 illustrates cyclic connections of VRG 0 (356) to each of the other VRGs (VRGs 1-7). This is for ease of explanation and not for limitation. In cyclic topologies of the present invention, every VRG in the topology will have cyclic connections to every other VRG in a manner analogous to that of VRG 0.

The example of FIG. 3 is a partial representation of a cyclic topology for ease of explanation. In embodiments implementing routing according to the present invention, each VRG will have the cyclic wiring configurations of VRG 0. This compete wiring is illustrated in FIG. 4. For further explanation, FIG. 4 sets forth a line drawing of a complete cyclic Dragonfly (155) topology in which each VRG (VRG 0-VRG 8) is comprised of a much more complex configuration of switches. In the example of FIG. 4, each VRG is comprised of switches (0-3) connected with local links (not shown) in an all-to-all fashion depicted in VRG 0 (402). The cyclic connections among the VRGs are illustrated with different line types to show the cycles. Switch 0 in each VRG is connected to other VRGs with the thin, solid line. As in FIG. 3, each cycle is a triangle, matching the two global links per switch in this example. Switch 1 in each VRG uses short dashed lines to form another part of the complete pattern. Switch 2 uses lines with long dashes and switch 3 uses heavy solid lines. In each case, only triangles are used, and together they form an all-to-all connection pattern among all of the VRGs. Both examples depicted in FIGS. 3 and 4 are shown in only one dimension. This is for explanation and not for limitation. In fact, cyclic Dragonfly topologies according to embodiments of the present invention may comprise many dimensions as will occur to those of skill in the art.

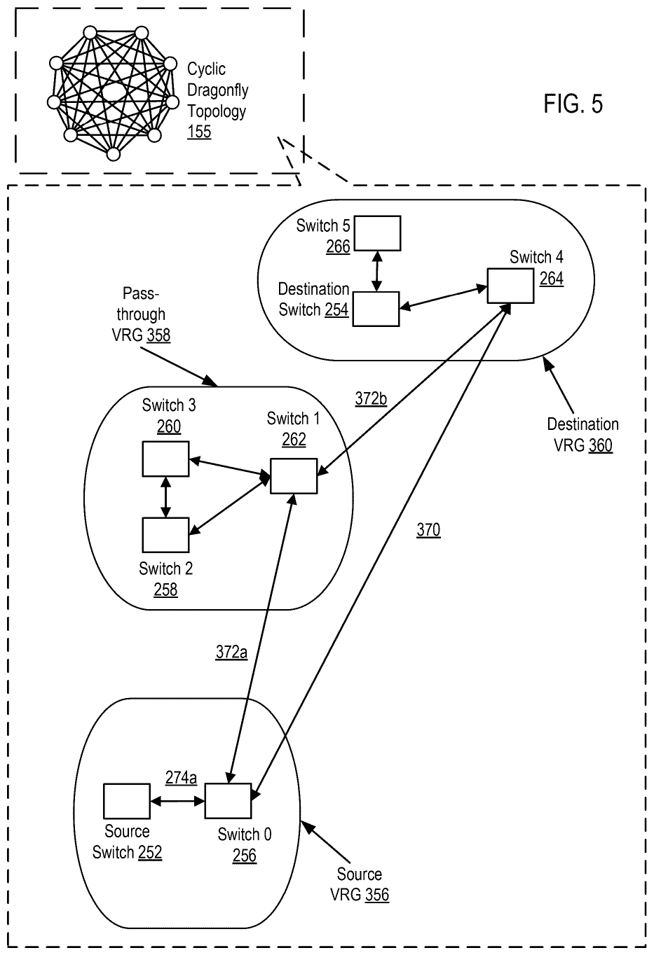

For further explanation, FIG. 5 sets forth a block diagram of a system for routing in a multi-computer network according to example embodiments of the present invention. The multi-switch cyclic network of FIG. 5 is configured as a cyclic topology (155). The example of FIG. 5 includes a callout that illustrates a single cycle (550) of three VRGs, a source VRG (356), a destination VRG (360), and a pass-through VRG (358). The example cycle (550) of VRGs (356, 358, and 360) are implemented with three global links (370, 372a, and 372b).

As mentioned above, a cyclic connection is formed by connecting one switch from each VRG in a cyclic set of VRGs to the same switch in every other VRG in the cyclic set. In this example, source VRG (356) and destination VRG (360) are connected through the same single switch, switch 1, (262) in pass-through VRG (358). This creates a non-minimal path between source VRG (356) and destination VRG (360) that uses no local links in the pass-through VRG (358) thereby reducing latency and requiring only two-hop telemetry for non-minimal path evaluation according to embodiments of the present invention. In the cycle of FIG. 5, pass-through VRG (358) and destination VRG (360) are connected through the same single switch, switch 0, (256) in source VRG (356) creating a non-minimal path using link (372a) and link (370). Similarly, in the cycle (550) of FIG. 5, pass-through VRG (358) and source VRG (356) are connected through the same single switch, switch 4, (264) in destination VRG (360) creating a non-minimal path using link (372b) and link (370). Those of skill in the art will recognize that non-minimal routing using the cyclic connections of the present invention provide non-minimal routing that requires no local traffic on pass-through VRGs.

Turning to the example of FIG. 5 in more detail, a plurality of switches are assigned to a plurality virtual router groups (‘VRGs’) (356, 358, and 360) including a source VRG (356) that contains a source switch (252), a destination VRG (360) that contains a destination switch (254), and a pass-through VRG (358) that contains a plurality of switches (258, 260, 262) which are neither the source switch (252) or the destination switch (254). In the example of FIG. 5, a packet from the source switch (252) to the destination switch (254) passes through switch 0 (256) in the source VRG (356). Switch 0 determines from telemetry data describing packet congestion on cables between the switch 0 (252) in source VRG to switch 4 (264) in destination VRG. If the telemetry data dictates it is more efficient to use a non-minimal path from switch 0 (256) in source VRG to switch 4 (264) in destination VRG, then the packet is routed along a non-minimal path on links (372a and 372b) through switch 1 (262) which is the same switch having a direct global link to both source VRG (256) and destination VRG (360) eliminating any local traffic in the pass-through VRG (358).

Local links may be and often are used in the source VRG and the destination VRG in routing according to embodiments of the present invention, but no local links are used in the pass-through VRG. In this manner, the method and system of FIG. 5 provides efficient non-minimal routing.

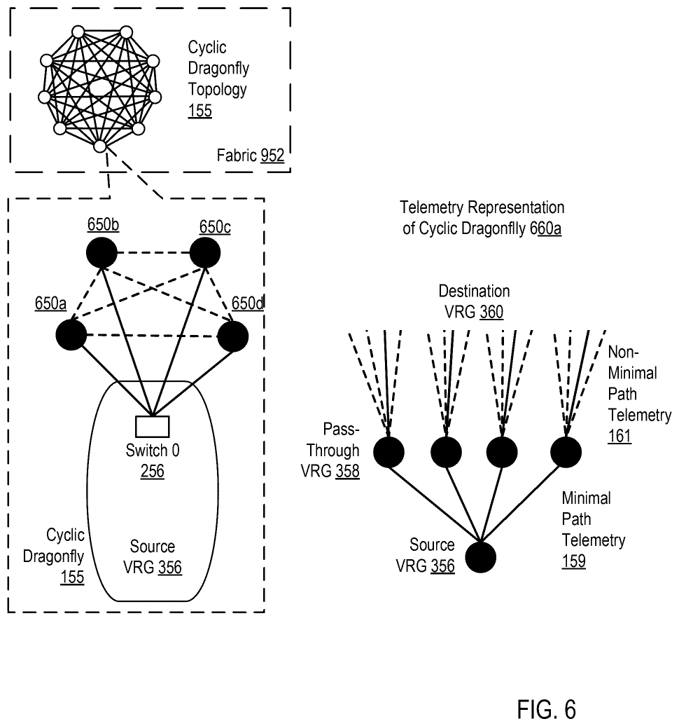

Those of skill in the art will recognize that the selection of whether to use a minimal path, and if so which path to take, is greatly improved by the cyclic topologies of the present invention. For further explanation, FIG. 6 sets forth a line drawing illustrating example telemetry advantages of cyclic topologies. Because the cyclic wiring of the example of FIG. 6 ensures a non-minimal two-hop path through a pass-through VRG is available, only two-hops of telemetry data is required to evaluate whether there is a more efficient non-minimal path from the source VRG to the destination VRG. FIG. 6 illustrates the telemetry advantage provided by the cyclic wiring of the present invention. In the example of FIG. 6, a five VRG cycle within a cyclic Dragonfly (155) topology is illustrated from the perspective of switch 0. Switch 0 (256) has a global link to each VRG in the topology represented by the solid lines between Switch 0 and each of the other VRGS (650a-650d) in the cycle. In the example of FIG. 6, the other VRGs have a global link to one another which are represented with dotted lines. Each of the links in the example of FIG. 6 are global. Therefore, solid lines represent a minimal path between switch 0 (256) and all the other VRGs (650a-650d). A non-minimal path from switch 0 (256) in VRG 0 (356) exits between VRG 0 and every other VRG (650a-650d) represented by a solid and dashed line.

Because the topology is cyclic, using a non-minimal path from Switch 0 in the source VRG (356) to any other VRG may be carried out through a switch that also has a direct global connection to the destination VRG. That is illustrated by non-minimal path telemetry depicted in the telemetry representation (660a) of the cyclic Dragonfly to the right of the cyclic Dragonfly (155) in FIG. 6. The non-minimal path telemetry (161) illustrates that one switch in each pass-through VRG (358) has a direct global link to at least one destination VRG (360) which is represented as the solid line. Thus, regardless of which VRG is the destination at least one pass-through VRG has a switch with a global link to the destination VRG and the source VRG, and as such, no more than two-hops are required from the source VRG (356) to the destination VRG (360). The telemetry tree data structure, and the computation required to process it, is limited to two tiers and has minimal breadth at each tier. This makes selection of the non-minimal path is extremely efficient.

One of skill in the art will immediately recognize that if local traffic in pass-through VRGs were not eliminated by the cyclic connections of the present invention, more telemetry data is required and more expensive calculations are required to determine the most efficient non-minimal path. This causes additional latency in receiving and processing the additional telemetry information needed to make that determination. These costs compound the latency of traversing a local hop to deliver the telemetry of the second global link in the non-minimal path, as is required without a cyclic connection. The inefficiencies of conventional Dragonfly topologies with no cyclic connections are further exacerbated by VRGs that do not internally have an all-to-all relationship among the switches. For example, a traditional Megafly topology requires selection from multiple switches at the edge of the VRG but also local switches within the VRG. Furthermore, because traditional Megaflies use a two-tier tree structure in the VRGs which is not an all-to-all configuration, extremely inefficient hops may occur within VRG on local links.

It should be noted that not only is selection of a non-minimal path aided by cyclic configurations of the present invention, so too is the selection of minimal paths. Because the efficient non-minimal path exists, the computational overhead to select the minimal path when it is the most efficient is also reduced.

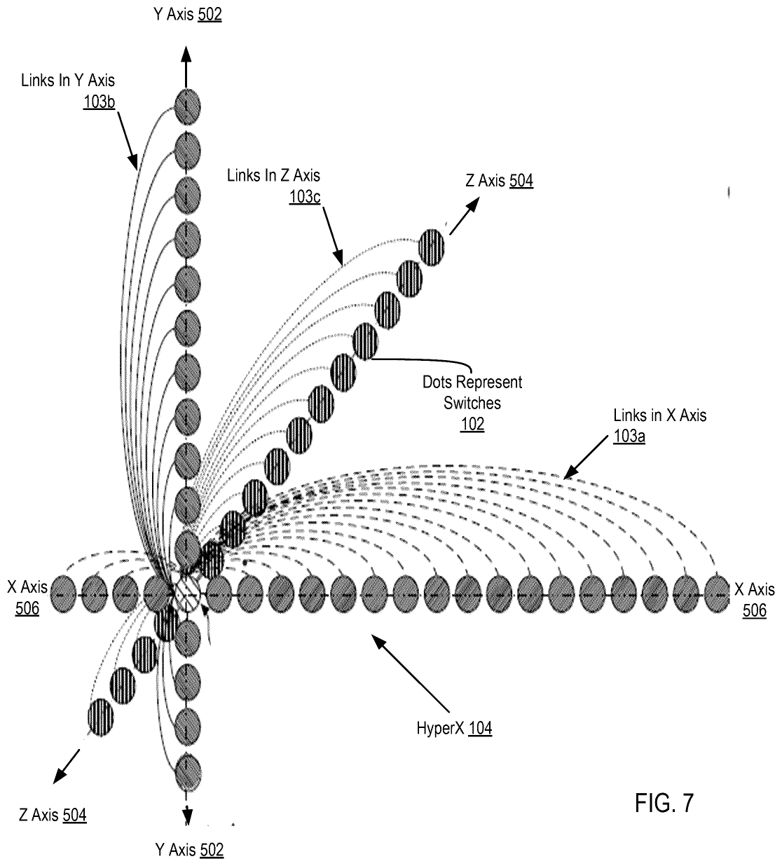

As mentioned above, cyclic topologies according to embodiments of the present invention may employ many configurations for switches within each VRG. For further explanation, FIG. 7 sets forth a topology useful with and benefitting routing in a multi-switch cyclic computer topology according to embodiments of the present invention. The topology of FIG. 7 is implemented as a HyperX (104) which may be used as a configuration for switches within a VRG according to embodiments of the present invention. In the example of FIG. 7, each dot (102) in the HyperX (104) represents a switch. Each switch (102) is connected by a link (103). The HyperX topology of FIG. 7 is depicted as an all-to-all topology in three dimensions having an X axis (506), a Y axis (502), and a Z axis (504). The use of three dimensions in the example of FIG. 7 is for example and explanation, not for limitation. In fact, a HyperX topology may have many dimensions with switches and links administered in a manner similar to the simple example of FIG. 7.

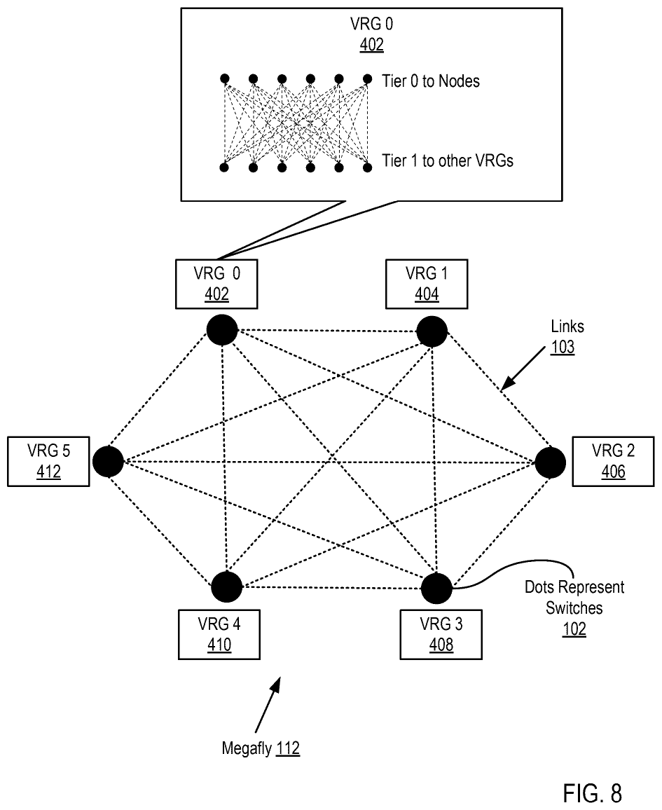

For further explanation, FIG. 8 sets forth another topology both useful with and benefitting from routing in a multi-switch cyclic computer topology according to embodiments of the present invention. The topology of FIG. 8 is implemented as a Megafly (112). The Megafly (112) topology of FIG. 8 is an all-to-all topology of switches and links among a set of VRGs-VRG 0 (402), VRG 1 (404), VRG 2 (406), VRG 3 (408), VRG 4 (410), and VRG 5 (412). In the example Megafly topology of FIG. 8, within each VRG (402-412) is itself another topology of switches and links implemented as a two-tier fat tree (402). This configuration is illustrated as VRG 0 (402) in this example.

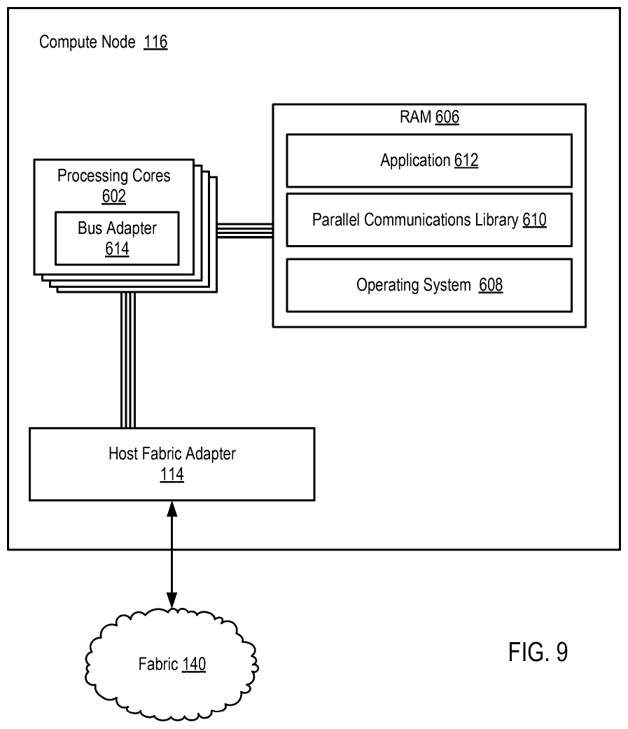

For further explanation, FIG. 9 sets forth a block diagram of a compute node useful in routing in a multi-computer network according to embodiments of the present invention. The compute node (116) of FIG. 9 includes processing cores (602), random access memory (‘RAM’) (606) and a host fabric adapter (114). The example compute node (116) is coupled for data communications with a fabric (140) for high-performance computing. The fabric (140) of FIG. 9 is implemented as a unified computing system that includes interconnected nodes, switches, links, and other components that often look like a weave or a fabric when seen collectively. As discussed above, the nodes, switches, links, and other components, of FIG. 9 are also implemented as a topology—that is, the connectivity pattern among switches, HFAs, and the bandwidth of those connections.

Stored in RAM (606) in the example of FIG. 9 is an application (612), a parallel communications library (610), and an operating system (608). Common uses for high-performance computing environments often include applications for complex problems of science, engineering, business, and others.

A parallel communications library (610) is a library specification for communication between various nodes and clusters of a high-performance computing environment. A common protocol for HPC computing is the Message Passing Interface (‘MPI’). MPI provides portability, scalability, and high-performance. MPI may be deployed on many distributed architectures, whether large or small, and each operation is often optimized for the specific hardware on which it runs. The application (612) of FIG. 9 is an application running on a high-performance computing environment using routing in a multi-switch cyclic computer topology according to embodiments of the present invention.

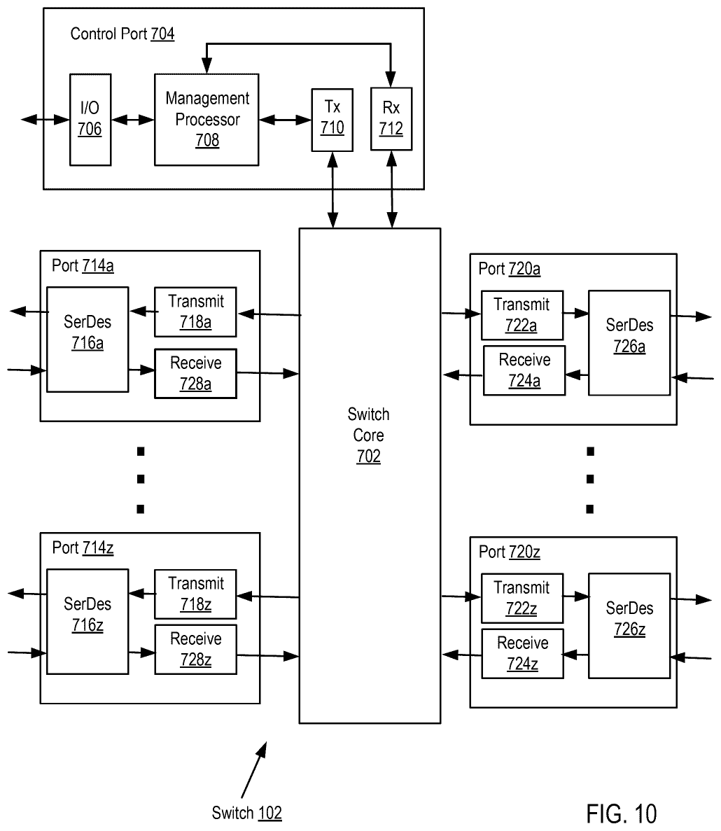

For further explanation, FIG. 10 sets forth a block diagram of an example switch. The example switch (102) of FIG. 10 includes a control port (704), a switch core (702), and a number of ports (714a-714z) and (720a-720z). The control port (704) of FIG. 10 includes an input/output (‘I/O’) module, a management processor (708), and a transmission (710) and reception (712) controllers. The management processor (708) of the example switch of FIG. 10 maintains and updates routing tables for the switch to use in routing according to embodiments of the present invention. In the example of FIG. 10, each receive controller maintains the latest updated routing tables.

The example switch (102) of FIG. 10 includes a number of ports (714a-714z and 720a-720z). The designation of reference numeral 714 and 720 with the alphabetical appendix of a-z is to explain that there may be many ports connected to a switch. Switches useful according to embodiments of the present invention may have any number of ports more or less than 26 for example. Each port (714a-714z and 720a-720z) is coupled with the switch core (702) and has a transmit controller (718a-718z and 722a-722) and a receive controller (728a-728 and 724a-724z).

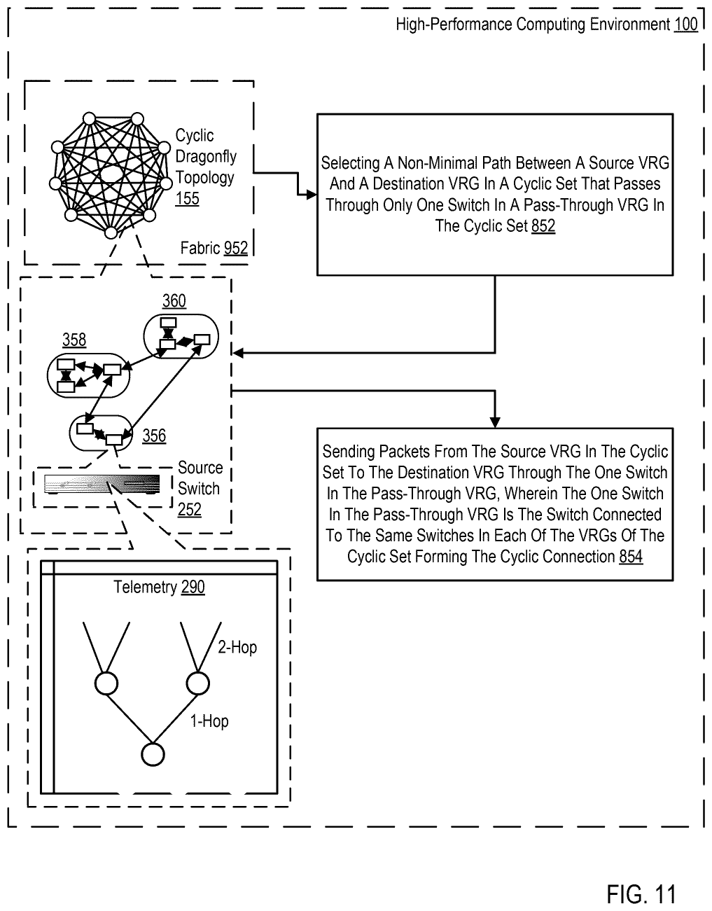

For further explanation, FIG. 11 sets forth a flowchart illustrating a method of routing in a multi-computer network. In the example of FIG. 11, the network includes a plurality of multi-switch virtual router groups (‘VRGs’) interconnected by only cyclic connections among the VRGs. As discussed above, each cyclic connection is formed by connecting one switch from each VRG in a cyclic set of VRGs to the same switch in every other VRG in the cyclic set and each switch in the cyclic set is connected in an all-to-all configuration. In the example of FIG. 11, every VRG in the network also has at least one cyclic connection with every other VRG in the network.

The method of FIG. 11 includes selecting (852) a non-minimal path between a source VRG and a destination VRG in a cyclic set that passes through only one switch in a pass-through VRG in the cyclic set. Selecting a non-minimal path between a source VRG and a destination VRG in a cyclic set that passes through only one switch in a pass-through VRG in the cyclic set may be carried out by selecting, in dependence upon the telemetry data, a non-minimal path with the least congestion to destination VRG. Switches according to embodiments of the present invention may include a module adapted for receiving and transmitting telemetry data. Such telemetry for feedback and congestion control provides fine-grained network load information including for example, queue length, transmitted bytes, timestamp, link capacity and other information. The switch includes information regarding the cyclic topology and interconnections and receives telemetry information from the other switches. Based on the topology and telemetry, the switch builds a telemetry tree identifying available paths and their congestion. The switch uses the telemetry tree for routing packets efficiently. Telemetry for adaptive routing is discussed in U.S. patent application Ser. Nos. 17/359,367; 17/359,358; and 17/359,371, all of which are incorporated by reference herein in their entirety.

Embodiments of the present invention requires only two-hop telemetry data provided to the switch in the source VRG connected to the same switches in the other VRGs of the cyclic set. Such a reduction in telemetry data requirements, reduces computational complexity and memory usage in selecting the non-minimal path. Furthermore, the cyclic configuration also reduces telemetry data propagation delay in selecting the non-minimal path, reduces packet latency, path length variation.

The method of FIG. 11 also includes sending (854) packets from the source VRG in the cyclic set to the destination VRG through the one switch in the pass-through VRG, wherein the one switch in the pass-through VRG is the switch connected to the same switches in each of the VRGs of the cyclic set forming the cyclic connection. Sending packets from the source VRG in the cyclic set to the destination VRG through the one switch in the pass-through VRG avoids hops on additional local links in the pass-through VRG. Avoiding hops on additional local links in the pass-through VRG reduces interference from other packet traffic. The pass-through VRG does not interfere with local traffic within the VRG. Local traffic is also not competing with pass-through traffic aiding efficiency within the VRG. Pass-through traffic on one switch does not interfere with pass-through traffic on another switch in the same VRG.

### Creation of Cyclic Dragonfly and Megafly Cable Patterns

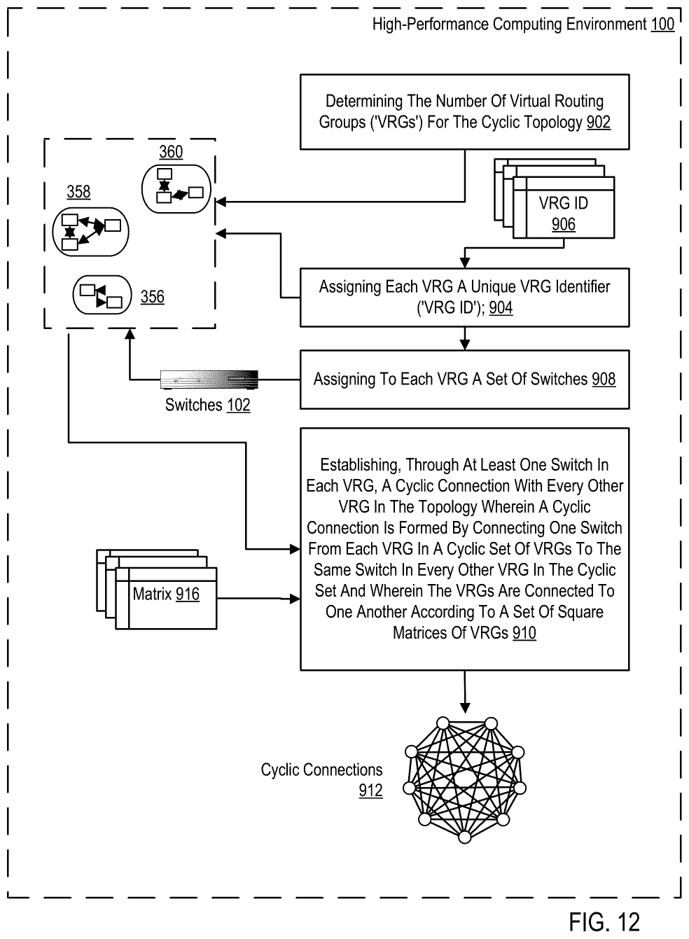

As discussed above, the cyclic topologies of the present invention have myriad benefits. The operation of such cyclic topologies has been discussed above. To enjoy the benefits discussed above, the cyclic topology must be created. For further explanation, therefore, FIG. 12 sets forth a flowchart illustrating an example method of creating a high-performance computing environment including a plurality of switches and a plurality of cables connecting the switches in a cyclic topology. Each cyclic connection is formed by connecting one switch from each VRG in a cyclic set of VRGs to the same switch in every other VRG in the cyclic set and each switch in the cyclic set is connected in an all-to-all configuration. Every VRG in the cyclic topology also has at least one cyclic connection with every other VRG in the topology. A cyclic connection provides a minimal path between every VRG pair in the cyclic set and also provides a non-minimal path between the same VRG pair in the cyclic set through a switch directly connected to both VRGs of the VRG pair.

The method of FIG. 12 includes determining (902) the number of virtual routing groups (‘VRGs’) (356, 358, 360) for the cyclic topology. The number of VRGs in the cyclic topology may be determined as the square of one plus the maximum number of global links on any switch in any VRG. As those of skill in the art, the maximum number of global links on any switch is established by many factors such as cost, need, form factor, and others as will occur to those of skill in the art.

In some embodiments, determining (902) the number of virtual routing groups (‘VRGs’) (356, 358, 360) for the cyclic topology includes selecting a number of VRGs such that the square root of the number of VRGs is a prime number. That is, in the example of FIG. 12, the number of VRGs (“N”) is determined such that \sqrt{N} is a prime number.

The method of FIG. 12 also includes assigning (904) each VRG (356, 358, 360) a unique VRG identifier (‘VRG ID’) (906). A unique VRG identifier may be implemented as a numeric identifier such as an ID from 0 to the number of VRGs selected minus one.

The method of FIG. 12 includes assigning (908) to each VRG a set of switches (102). Assigning (908) to each VRG a set of switches (102) according to the method of FIG. 12 may be carried out by assigning to each VRG a number of switches equal to the square root of the number of VRGs plus one. That is, the number of switches (“S’) in each VRG is \sqrt{N}+1. As mentioned above, the switches of each VRG are typically connected in an all-to-all configuration such that each switch within each VRG to is connected to every other switch in the VRG. In some embodiments, the switches within a VRG are connected as a HyperX topology, a Dragonfly topology, a two-tier tree topology, and others as will occur to those of skill in the art. While HyperX and two-tier trees are specifically mentioned, this is for explanation and not for limitation. In fact, the switches within a VRG may be connected in any way that ensures a path between all pairs of switches in the VRG as will occur to those of skill in the art.

The method of FIG. 12 includes establishing (910), through at least one switch in each VRG, a cyclic connection with every other VRG in the topology wherein a cyclic connection is formed by connecting one switch from each VRG in a cyclic set of VRGs to the same switch in every other VRG in the cyclic set and wherein the VRGs are connected to one another according to a set of square matrices of VRGs. Each matrix in the set of matrices typically has rows and columns whose length is the square root of the number of VRGs in the cyclic set. Each matrix in the set is square such that there are the same number of rows and columns, and the rows and columns are the same length. In some embodiments, the VRGs are connected to one another according to a set of square matrices of VRGs that have rows and columns that are a prime number in length.

In some embodiments, each VRG has one and only one direct global connection to each of the other VRG's in the cyclic set. In such embodiments, no two same VRG identifiers will reside in any row of any matrix in the set of matrices of the cyclic topology where there is only one global link between pairs of VRGs. However, this is not a requirement. In some configurations, VRGS may have more than one global link to another VRG and a switch in one cyclic set of VRGs forming a cyclic connection may also be in another cyclic set of VRGs forming another cyclic connection in the cyclic topology.

As discussed in more detail below, the number of matrices is the square root of the number of VRGs in the cyclic topology. Also discussed in more detail below, the first matrix, Matrix0, in the set of matrices is comprised of rows of VRG identifiers that begin with VRG identifier 0 and continue through VRG N−1, where N is the number of VRGs in the cyclic topology and wherein each row is \sqrt{N} in length and the second matrix, Matrix1, in the set of matrices is comprised of the transposition of Matrix 0. Furthermore, every subsequent matrix from the third matrix, Matrix 2, through matrix \sqrt{N} is comprised of the result of iteratively rotating the value of in each column of the previous matrix up the column by the value of column number identifier.

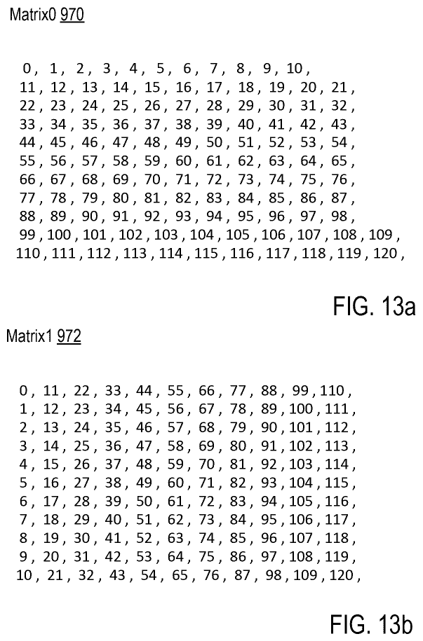

For further explanation, FIGS. 13a and 13b, FIGS. 14a and 14b, and 15a and 15b set forth matrices that illustrate the permutation properties of an example set of matrices that implement the configuration of a cyclic topology according to embodiments of the present invention. In the example below there are two basic conditions on each matrix in the set of matrices describing the configuration of the cyclic topology. The first condition is that each matrix is a square matrix. The second condition is that the number of rows and columns is a prime number which is the square root of the number of VRGs in the cyclic topology.

The example matrices of FIGS. 13a and 13b, FIGS. 14a and 14b, and 15a and 15b illustrate the first three matrices and the last matrices of a cyclic topology with 121 VRGs (“N”). In the example of FIGS. 13a and 13b, FIGS. 14a and 14b, and 15a and 15b, the VRGs are identified with VRG identifiers 0-120 (N−1). As such, each row and column will have 11 VRG identifiers because the square root of 121 (N) is 11 and 11 is a prime number. The matrices of this example are √Nx√N.

Matrix 0 illustrated in FIG. 13a has a first row comprised of identifiers 0-10 which is √N−1. Matrix 0 is arranged as VRG identifiers 0-120.

FIG. 13b illustrates Matrix 1 (972). To create Matrix1 (972), Matrix 0 is transposed. Those of skill in the art will recognize that as a result of transposing Matrix 0, Matrix1 has columns that are the rows of Matrix0. Those of skill in the art will also recognize that no two identifiers in any row of Matrix0 will appear in a row of Matrix1 because all identifiers are unique.

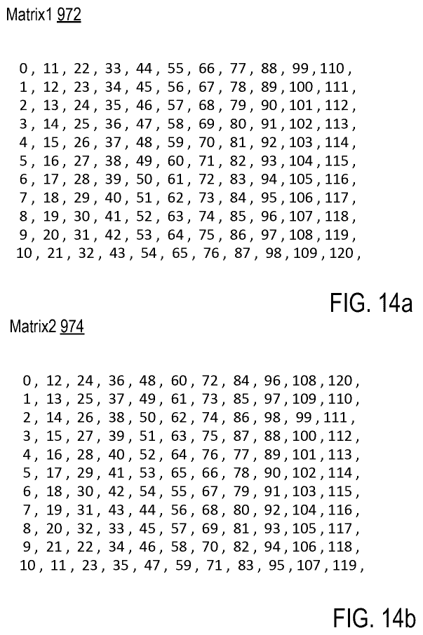

FIGS. 14a and 14b illustrate the creation of Matrix 2 (974) from Matrix 1 (972). Matrix 2 (974) is created by rotating up each column of Matrix1 (972) now illustrated as FIG. 14a by the column number (column numbers are identified as 0 to √N−1). This rotation of each column is continued until Matrix √N. Matrix0 through Matrix √N gives √N+1=S matrices for the S switches in a VRG.

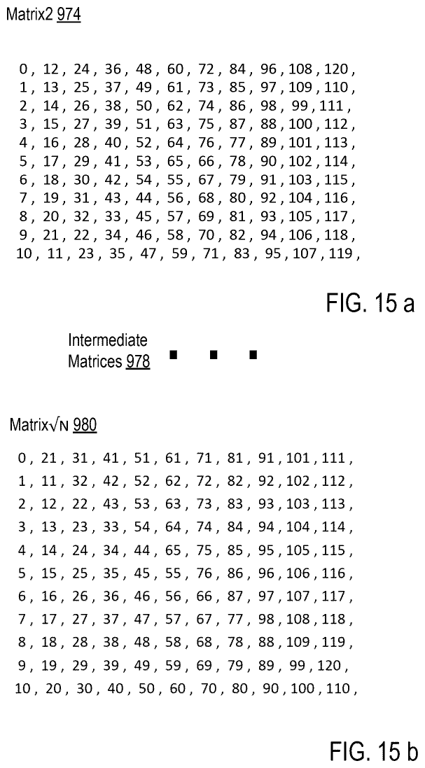

FIGS. 15a and 15b illustrate the result of repeating the rotation from Matrix 2 (974) to Matrix √N. Ellipses represent the Intermediate matrices (978) each created using the same rotation used to create Matrix 2.

The example matrices of FIGS. 13a and 13b, FIGS. 14a and 14b, and 15a and 15b according to embodiments of the present invention demonstrate that no two identifiers in any row of any matrix will appear in any row of any other matrix. In this the example of FIGS. 13a and 13b, FIGS. 14a and 14b, and 15a and 15b invention √N+1 is the number of switches S in a VRG. The S matrices (Matix0 to Matrix √N) are used to form the cyclic connection pattern on the switches. The number of global links on a switch that go to other VRGs is √N−1.

These matrices translate into the following connection pattern on VRG0:
Switch1: 1, 2, 3, 4, 5, 6, 7, 8, 9, 10
Switch2: 11, 22, 33, 44, 55, 66, 77, 88, 99, 110
Switch3: 12, 24, 36, 48, 60, 72, 84, 96, 108, 120
Switch4: 13, 26, 39, 52, 65, 67, 80, 93, 106, 119
Switch5: 14, 28, 42, 45, 59, 73, 87, 90, 104, 118
Switch6: 15, 30, 34, 49, 64, 68, 83, 98, 102, 117
Switch7: 16, 32, 37, 53, 58, 74, 79, 95, 100, 116
Switch8: 17, 23, 40, 46, 63, 69, 86, 92, 109, 115
Switch9: 18, 25, 43, 50, 57, 75, 82, 89, 107, 114
Switch10: 19, 27, 35, 54, 62, 70, 78, 97, 105, 113
Switch11: 20, 29, 38, 47, 56, 76, 85, 94, 103, 112
Switch12: 21, 31, 41, 51, 61, 71, 81, 91, 101, 111

VRG1 through VRG120, are connected to VRG0 once.

For further explanation, the matrices in the example cyclic configuration depicted in FIGS. 13a and 13b, FIGS. 14a and 14b, and 15a and 15b may be formed as described by the pseudocode below:

```
    for (row = 0 ; row < swts ; ++row) {
      for (col = 0 ; col < swts; ++col) {
        gblAbs[row][col] = (row*(gbls+1)+col);
        transp[col][row] = (row*(gbls+1)+col);
      }
          }
  for (set=0 ; set<swts ; set++) {
      for (row=0 ; row<swts−1 ; row++) {
        for (col = 0 ; col < gbls+1 ; col ++) {
            if (!set) {
              allSet[set][row][col] = gblAbs[row][col]; //sets Matrix0
            } else {
              shift = (set 1);
              if (!shift)
                allSet[set][row][col] = transp[row][col]; //sets Matrix1
              else
                allSet[set][row][col] =
transp[(row+col*shift)%(swts−1)][col]; //sets remaining matrices
  }
        }
      }
    }
```

The cyclic connection pattern generation illustrated above requires the number of switches in a VRG to be 2 more than the number of global links on the switches, and the number of switches in a VRG to be one more than a prime number. While this illustrative example uses one global link between VRGs, the approach is generally applicable when there are more than one global link between VRGs with appropriate adjustments to number of switches and number of VRGs.

While the set up of cyclic connections as per this algorithm requires number of VRGs to be square of a prime number, any number of VRGs less than this maximum and greater than the square of next lower prime number can be supported. This is achieved by removing VRGs one at a time from bottom right of Matrix0 (970) to top of that column and then moving on to the bottom of the next column to the left. The order would be:

120, 109, 98, 87, 76, 65, 54, 43, 32, 21, 10, 119, 108, and so on until 50 VRGs remain in the matrix.

Consider the example when the 11 VRGs in the last column of Matrix0 (970) are removed. The same VRGs shall be removed from Matrix1 (972) and all others till Matrix\sqrt{N} (980). VRG0 connection pattern for this set of 110 VRGs becomes:
Switch1: 1, 2, 3, 4, 5, 6, 7, 8, 9 10
Switch2: 11, 22, 33, 44, 55, 66, 77, 88, 99, 110
Switch3: 12, 24, 36, 48, 60, 72, 84, 96, 108, 120
Switch4: 13, 26, 39, 52, 67, 80, 93, 106, 119
Switch5: 14, 28, 42, 45, 59, 73, 90, 104, 118
Switch6: 15, 30, 34, 49, 64, 68, 83, 102, 117
Switch7: 16, 37, 53, 58, 74, 79, 95, 100, 116
Switch8: 17, 23, 40, 46, 63, 69, 86, 92, 115
Switch9: 18, 25, 50, 57, 75, 82, 89, 107, 114
Switch10: 19, 27, 35, 62, 70, 78, 97, 105, 113
Switch11: 20, 29, 38, 47, 56, 85, 94, 103, 112
Switch12: 31, 41, 51, 61, 71, 81, 91, 101, 111

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of routing in a multi-computer network comprising a plurality of multi-switch virtual router groups (‘VRGs’) interconnected by only cyclic connections among the VRGs, wherein a cyclic connection is formed by connecting one switch from each VRG in a cyclic set of VRGs to the same switch in every other VRG in the cyclic set and wherein each switch in the cyclic set is connected in an all-to-all configuration, and wherein every VRG in the network has at least one cyclic connection with every other VRG in the network; the method comprising:
selecting a non-minimal path between a source VRG and a destination VRG in a cyclic set that passes through only one switch in a pass-through VRG in the cyclic set; and
sending packets from the source VRG in the cyclic set to the destination VRG through the one switch in the pass-through VRG, wherein the one switch in the pass-through VRG is the switch connected to the same switches in each of the VRGs of the cyclic set forming the cyclic connection.

2. The method of claim 1 wherein selecting a non-minimal path between a source VRG and a destination VRG in a cyclic set that passes through only one switch in a pass-through VRG in the cyclic set further comprises selecting, in dependence upon the telemetry data, a non-minimal path with the least congestion to destination VRG.

3. The method of claim 2 wherein selecting a non-minimal path between a source VRG and a destination VRG in a cyclic set that passes through only one switch in a pass-through VRG in the cyclic set further comprises selecting the non-minimal path in dependence of only two-hop telemetry data provided to the switch in the source VRG connected to the same switches in the other VRGs of the cyclic set.

4. The method of claim 3 wherein selecting a non-minimal path between a source VRG and a destination VRG in a cyclic set that passes through only one switch in a pass-through VRG in the cyclic set further comprises reducing computational complexity and memory usage in selecting the non-minimal path.

5. The method of claim 2 wherein selecting a non-minimal path between a source VRG and a destination VRG in a cyclic set that passes through only one switch in a pass-through VRG in the cyclic set further comprises reducing telemetry data propagation delay in selecting the non-minimal path.

6. The method of claim 1 wherein selecting a non-minimal path between a source VRG and a destination VRG in a cyclic set that passes through only one switch in a pass-through VRG in the cyclic set reduces packet latency.

7. The method of claim 1 wherein selecting a non-minimal path between a source VRG and a destination VRG in a cyclic set that passes through only one switch in a pass-through VRG in the cyclic set reduces path length variation.

8. The method of claim 1 wherein sending packets from the source VRG in the cyclic set to the destination VRG through the one switch in the pass-through VRG further comprises avoiding hops on additional local links in the pass-through VRG.

9. The method of claim 8 wherein avoiding hops on additional local links in the pass-through VRG further comprises reducing interference from other packet traffic.

10. The method of claim 1 wherein each VRG in the cyclic set has a plurality of switches with an all-to-all connection configuration.

11. The method of claim 1 wherein each VRG in the cyclic set has a plurality of switches arranged as a two-tier fat tree.

12. A multi-computer interconnection network, the network comprising:
multi-switch virtual router groups (‘VRGs’) interconnected to form a cyclic connection among the VRGs,
wherein a cyclic connection is formed by connecting one switch from each VRG in a cyclic set of VRGs to the same switch in every other VRG in the cyclic set; and
wherein every VRG in the network has at least one cyclic connection with every other VRG in the network.

13. The network of claim 12 wherein each switch maintains telemetry data at least two-hops downstream from the switch.

14. The method of claim 12 wherein each VRG in the cyclic set has a plurality of switches with an all-to-all connection configuration.

15. The method of claim 12 wherein each VRG in the cyclic set has a plurality of switches arranged as a two-tier fat tree.

16. A system of routing in a multi-computer network comprising a plurality of multi-switch virtual router groups (‘VRGs’) interconnected to form a plurality of cyclic connections among the VRGs, wherein a cyclic connection is formed by connecting one switch from each VRG in a cyclic set of VRGs to the same switch in every other VRG in the cyclic set and wherein each switch in the cyclic set is connected in an all-to-all configuration, and wherein every VRG in the network has at least one cyclic connection with every other VRG in the network; the system configured for:
selecting a non-minimal path between a source VRG and a destination VRG in a cyclic set that passes through only one switch in a pass-through VRG in the cyclic set and
sending packets from the source VRG in the cyclic set to the destination VRG through the one switch in the pass-through VRG, wherein the one switch in the pass-through VRG is the switch connected to the same switches in each of the VRGs of the cyclic set forming the cyclic connection.

17. The system of claim 16 further configured for selecting the non-minimal path in dependence of only two-hop telemetry data.

18. The system of claim 16 further configured for avoiding hops on additional local links in the pass-through VRG.

19. The system of claim 16 wherein each VRG in the cyclic set has a plurality of switches with an all-to-all connection configuration.

20. The system of claim 16 wherein each VRG in the cyclic set has a plurality of switches arranged as a two-tier fat tree.

21. A system of routing in a multi-computer network comprising a plurality of multi-switch virtual router groups (‘VRGs’) interconnected to form a plurality of cyclic connections among the VRGs, wherein a cyclic connection is formed by at least three links connecting three switches in an all-to-all configuration and wherein each of the at least three switches resides in a different VRG and wherein every VRG in the network has at least one cyclic connection with every other VRG in the network; the system configured for:
selecting a non-minimal path between a source VRG and a destination VRG in a cyclic set that passes through only one switch in a pass-through VRG in the cyclic set and
sending packets from the source VRG in the cyclic set to the destination VRG through the one switch in the pass-through VRG, wherein the one switch in the pass-through VRG is the switch connected to the same switches in each of the VRGs of the cyclic set forming the cyclic connection.

22. A method of routing in a multi-computer network comprising a plurality of multi-switch virtual router groups (‘VRGs’) interconnected by only cyclic connections among the VRGs, wherein a cyclic connection comprises a set of global links connecting a set of VRGs such that traffic amongst the VRGs may pass through any VRG of the set without the use of local links, and wherein every VRG in the network has at least one cyclic connection with every other VRG in the network; the method comprising:
selecting a non-minimal path between a source VRG and a destination VRG in a cyclic set that passes through only one switch in a pass-through VRG in the cyclic set; and
sending packets from the source VRG in the cyclic set to the destination VRG through the one switch in the pass-through VRG, wherein the one switch in the pass-through VRG is the switch connected to the same switches in each of the VRGs of the cyclic set forming the cyclic connection.
